(19) United States
(12) Patent Application Publication
(10) Pub. No.: US 2014/0040006 A1
(43) Pub. Date: Feb. 6, 2014

(54) POPULATING PRODUCT RECOMMENDATION LIST

(71) Applicants: Filippo Balestrieri, Mountain View, CA (US); Shyam Sundar Rajaram, San Francisco, CA (US)

(72) Inventors: Filippo Balestrieri, Mountain View, CA (US); Shyam Sundar Rajaram, San Francisco, CA (US)

(21) Appl. No.: 13/562,800

(22) Filed: Jul. 31, 2012

(51) Int. Cl. G06Q 30/02

(52) U.S. Cl. 705/14.41; 705/14.66

(57) ABSTRACT

A computer-implemented method for populating a product recommendation list can include identifying a first set of products using customer data and a second set of products using social network data, identifying a third set of products, wherein the third set of products includes products in the second set of products and not in the first set of products, calculating a product score for each product in the second set of products, and populating the product recommendation list of the customer with a subset of the first set of products and a subset of the third set of products based on the calculated product scores.

### BACKGROUND

The Internet is a growing frontier for advertising due to an increasing use of the Internet by consumers. For instance, a company and/or seller can use advertisements on the Internet to attract customers. The advertisements can contain a promotion to market a product and can be used in a marketing campaign. A promotion can include an act to advertise a product, such as offering a special price to a customer and/or consumer for a product.

### BRIEF DESCRIPTION OF THE DRAWINGS

FIG. 1 is a block diagram illustrating an example of a method for populating a product recommendation list according to the present disclosure.

FIG. 2 is a flow chart illustrating an example process for populating a product recommendation list according to the present disclosure.

FIG. 3 is a block diagram illustrating a processing resource, a memory resource, and a computer-readable medium according to the present disclosure.

### DETAILED DESCRIPTION

A user's action on the Internet, such as browsing activity and buying tendencies, can be used by an advertiser to determine products to advertise to the user. For instance, an advertiser can determine a group of users that may have an affinity toward a product based on past purchases, browsing activity of the user, and/or past purchases of similar users (e.g., other users in the group of users).

The appearance of well-structured social networks has opened new possibilities for advertisers to promote their products to their customer base. A number of strategies can be used to harvest social network information for promoting products. For example, social network related information can be used to determine a user on the social networks affinity towards a product. Additionally, an advertiser can provide incentives, such as a discount on a product, for a user to spread information about a specific deal through their social network. However, using a number of strategies in unison can result in overlap of recommendations from peers in a social network and from an automated product recommendation engine.

In contrast, examples of the present disclosure provide a manner to utilize social network-based product recommendations and social network-marketing campaigns to increase the probability of selling products as compared to using a single strategy while eliminating overlap. For instance, overlaps of recommendations may be eliminated by identifying and/or eliminating product recommendations determined from social-network information that are the same as a product identified using an automated product recommendation engine. An automated product recommendation engine, for instance, can include an application, information filtering system, and/or a control mechanism that can rank items on a database (e.g., products) for a user (e.g., predict a user's and/or customer's preference for the items on the database).

Further, information can be elicited regarding a specific user's (e.g. a customer) potential interest for products from the user's social network reaction to a marketing campaign. The combined information can be used to populate a product recommendation list for the user.

Examples of the present disclosure include methods, systems, and computer-readable medium storing a set of instructions to populate a product recommendation list. A computer-implemented method for populating a product recommendation list can include identifying a first set of products using customer data and a second set of products using social network data, identifying a third set of products, wherein the third set of products includes products among and/or in the second set of products and not among and/or in the first set of products, calculating a product score for each product in the second set of products, and populating the product recommendation list of the customer with a subset of the first set of products and a subset of the third set of products based on the calculated product scores.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit or digits correspond to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Also, as used herein, “a number of” an element and/or feature can refer to one or more of such elements and/or features.

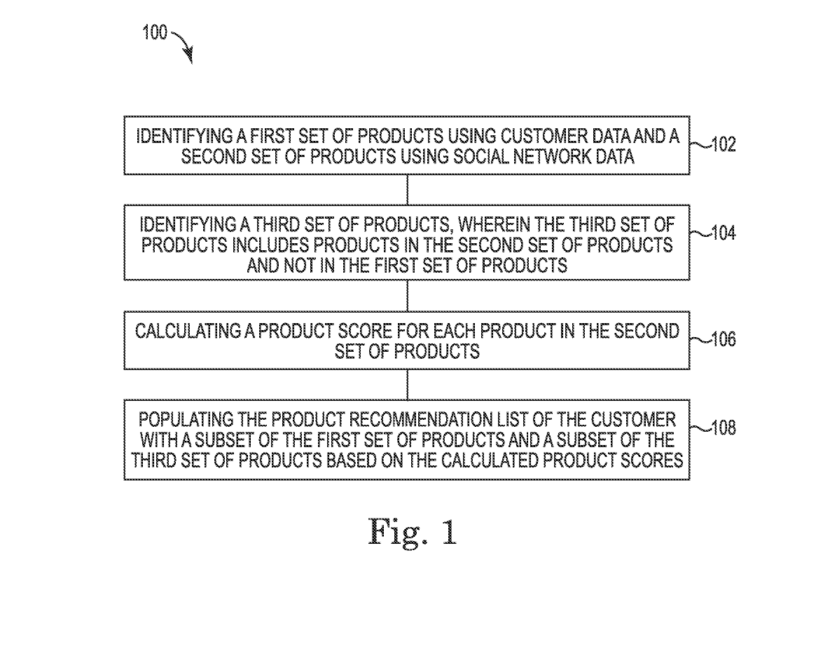

FIG. 1 is a block diagram illustrating an example of a method 100 for populating a product recommendation list according to the present disclosure. The method 100 can, for instance, include a computer-implemented method and can be performed by a computing device. A product recommendation list, for example, can include a list of products to recommend to a customer using an advertisement on the Internet.

The method 100 can include leveraging activity in a social network, such as social network-marketing campaigns, while eliminating overlaps of recommendations that a customer may receive. A social network-marketing campaign can, for example, include inducing an action in a social network with incentives. For example, a customer in a social network can be incentivized with a discount on a product to find other users in their social network and/or to send messages to peers and/or friends. A social network, as used herein, can include a structure made up of a set of users (e.g., individual users and organizations) and the dyadic ties between the set of users, for example

At 102, the method 100 can include identifying a first set of products using customer data and a second set of products using social network data. The customer can include a specific user of the Internet and/or a social network. A user, as used herein, can include a person that uses the Internet and/or social network. For instance, customer data can include browsing history, past product purchases of the customer, and past product purchases of related customers. A related customer can include a customer with identified similar activities, tastes, browsing history, and purchasing history, among many other characteristics and/or observations.

Social network data can, for instance, include data of a social network associated with the customer. Social network data can include data relating to a subset of users in the customer's social network. The subset of users can include a number of users in the social network (e.g., potential customers) that belong to the customer's social network. The data associated with a social network of the customer can, for instance, include information regarding the given customer's social network. The information can include users that belong to the customer's social network (e.g., friends, followers, and contacts), social activity of the customer (e.g., likes, comments, and tags), and social activity of users that belong to the customer's social network (e.g., recommendations).

For example, a first set of products can include a recommended set of products. The recommended set of products, for instance, can be determined using an automated product recommendation engine. The automated product recommendation engine can calculate an affinity score for each product in the first set of products based on the customer data.

The second set of products can include a social network-recommended set of products. The social network-recommended set of products can be determined using an automated product recommendation engine implemented using data elicited from the customer's social network. The automated product recommendation engine can calculate an affinity score for each product in the second set of products based on social network data.

An affinity score can include a representation of an affinity of a customer toward a product. For example, an affinity score of 0.99 for product X can indicated a higher likely affinity of the customer toward product X than for product Y with an affinity score of 0.51.

An affinity score can be calculated, in accordance with some examples of the present disclosure, using collaborative filtering. For example, collaborative filtering can include a technique for filtering for information and/or patterns by collaboration among multiple agents, viewpoints, data source, etc. Collaborative filtering can include automatic predictions (e.g., filtering) about the interest of a customer by collecting preference or taste information from many customers and/or users (e.g., collaborating). For example, if customer A and customer B visits a sports domain on the Internet, customer A may be more likely to visit and/or buy a same product as customer B than of a random customer.

Collaborative filtering can, for example, result in an affinity score that represents a potential affinity between a customer and a product using data relating to products the customer has, products related customers have, and the customer's browsing history. The affinity score can be specific to a customer but can use information from many customers and/or users.

Calculating an affinity score to identify a product in the first set of products, for example, can be based on customer data. For instance, customer data can include browsing history, past product purchases of the customer, and past product purchases of related customers.

Calculating an affinity score to identify a product in the second set of products, for example, can be based on social network data. Social network data can include data associated with users in the social network of the customer. Users in the social network of the customer can include a subset of users in the social network (e.g., a subset of total users in the social network). The subset of users in the social network can include the customer, friends of the customer, and users within the customer's social network (e.g., friends of the customer's friends).

For instance, collaborative filtering for a product in the second set of products can include mapping users in the customer's social network (e.g., subset of users) to a product to account for users that are closest to the customer. The subset of users can have a weight assigned and collaborative filtering can accommodate the weights. A weight of the user can include a determined degree of closeness of the user to the customer.

A closeness of a user to the customer, as used herein, can include a frequency of interactions between the customer and the user. For example, user 1 can be considered close to the customer based on the user 1 and the customer interacting frequently (e.g., once a day) as compared a user 2 and the customer (e.g., interacting once a month).

At 104, the method 100 can include identifying a third set of products, wherein the third set of products includes products among and/or in the second set of products and not among and/or in the first set of products (e.g., products in the second set of products that are not in the first set of products). The third set of products can include products among the second set that are new products not found in the first set of products. New products can include products that are different than the first set of products, for example. Thereby, the second set of products can be divided into two subsets of products: (i) a fourth set of products that are identified as in the first set of products (e.g., found in the first set of products) and (ii) the third set of products that are identified as new products not found in the first set of products.

At 106, the method 100 can include calculating a product score for each product in the second set of products. A product score can include a score, in addition to an affinity score, of a likely interest of a product to the customer based on social network data. In various examples of the present disclosure, a product score can be calculated for a subset of the second set of products (e.g., for products in the second set of products that belong to a set of recommended set of products, as discussed herein).

As used herein, a product score can include a function of measurable interactions and relationships in the social network of the customer. Measurable interactions can, for example, include influence of users on the customer and responsiveness of the customer to recommendations. Relationships in the social network can include a degree of closeness of each user to the customer. For instance, the product score can be based on a number of recommendations a customer has received from users (e.g., the customers peers and friends in the social network), a degree of closeness of each user to the customer, a degree of influence of each user that makes a recommendation to the customer, and past responsiveness of the customer to recommendations of users. An influence of the user on the customer can include past responsiveness of the customer to a recommendation of a product from the user. For example, a user in the social network may be considered influential if a recommendation from the user to the customer always leads to the customer downloading, buying, and/or viewing a product recommended.

The product score attached to a particular product in the second set of products can include:

score=ΣᵢCᵢIᵢRᵢ.

Wherein i can denote a number of users, such as the number of users the data is associated with. Cᵢ can denote a degree of closeness between the customer and userᵢ, and Iᵢ can denote a degree of influence of userᵢ. Rᵢcan denote an indication of a receptiveness of the customer towards recommendations. For example, Rᵢ can include an overall receptiveness of the customer to a recommendation and/or a receptiveness of the customer towards a recommendation of userᵢ. For instance, an overall receptiveness of the customer (e.g., Rᵢ) can include a constant for the customer, independent of userᵢ, indicating how receptive the customer is towards accepting product recommendations.

Each of the three factors (e.g., Cᵢ, Iᵢ, and Rᵢ) can include a numerical value. For instance, a numerical value can be between 0.0 and 1.0. As an example, Cᵢ can include a fraction of a total interaction between the customer and the userᵢ, Iᵢ can include a fraction of successful recommendations by userᵢ, and Rᵢ can include a constant for the customer.

A product with a high score can include a product that is recommended a plurality of times by a number of users in the social network, recommended a number of times by a number of close users (e.g., closeness) in the social network, and/or recommended by a number of influential users in the social network, for example.

In various examples of the present disclosure, a product score can be calculated for each product in a set of recommended products that is in and/or among the second set of products. For instance, a set of recommended products can include products from the first set of products and product from the third set of products. The set of recommended products can include products that are candidates for the product recommendation list.

The set of recommended products can be based on the calculated affinity scores and a threshold number of products to be populated on the product recommendation list. For instance, the set of recommended products can include a first number of products from the first set of products and a second number of products from the third set of products, wherein the first number of products and the second number of products have a higher affinity score than the remaining products in the first set of products and/or third set of products.

The threshold number of products to be populated can include a predetermined number of products. In some examples, the predetermined number of products can include a predetermined number of products from the first set of products (e.g., the first number of products) and a predetermined number of products from the third set of products (e.g., the second number of products). Thereby, the set of recommended products can include the predetermined first number of products from the first set of products with an affinity score that is higher than the remaining products in the first set of products and a predetermined second number of products from the third set of products with an affinity score that is higher than the remaining products in the third set of products.

The product score can be calculated for each product in the set of recommended products that is among the second set of products. For instance, a product score can be calculated for each product in the first number of products that is among the second set of products and each product in the second number of products. A product in the set of recommended products that is not among the second set of products (e.g., product that is unique to the first set of products), may not have a product score calculated.

At 108, the method 100 can include populating a product recommendation list of the customer with a subset of the first set of products and a subset of the third set of products based the calculated product scores. For instance, the populated product recommendation list can include a number a products with a higher affinity score than a remaining number of products in the first set of products and/or a higher affinity score than a remaining number of products in the third set of products.

In some examples, the subset of products of the first set of products and the third set of products can include products in the set of recommended products that are not in the second set of products and products among the second set of products with a calculated product score satisfies a criterion. The criterion can include a predetermined threshold product score and/or user action (e.g., download product, select product, buy product, and click advertisement). For instance, a product with a calculated product score that is higher than the predetermined threshold product score and has not been downloaded, bought, selected and/or clicked by the customer on can be eliminated from the product recommendation list of the customer and/or set of recommended products. User action, for instance, can be determined, identified, and/or evaluated using social network data.

In various examples, a number of products populated on the product recommendation list for the customer may not have a product score calculated. For instance, a product on the product recommendation list that is among the subset of first products and not among the second set of products, can be populated on the product recommendation list without a calculated product score.

Thereby, in accordance with some examples of the present disclosure, a criterion can include criteria (e.g., plurality of criterions) and/or a multi-step criterion. For instance, a first criterion and/or first step of the criterion can include the product being among the set of recommended products (e.g., higher affinity score than other products and/or threshold affinity score). If the product satisfies the first criterion and/or first step, a second criterion and/or second step of the criterion can be evaluated. A second criterion and/or second step of the criterion can include that the product has a product score below a threshold product score. A product with a product score below a threshold and/or without a product score calculated, can be added to the product recommendation list and/or remain on the set of recommended products.

A product that has a product score above a threshold product score can be evaluated under a third criterion and/or third-step of the criterion, for example. A third criterion and/or third step of the criterion can include user action and/or indication of customer interest in the product. For instance, user action can include the customer downloading, buying, selecting and/or clicking on a product and/or advertisement. A product with a score above the threshold and no user action may not satisfy the criteria and/or multi-step criterion. For instance, a product from the set of recommended products that does not satisfy a criterion among the criteria and/or a step of the criterion can be replaced in the set of recommended products and/or product recommendation list by a product from the same set of origin (e.g., first set of products and third set of products).

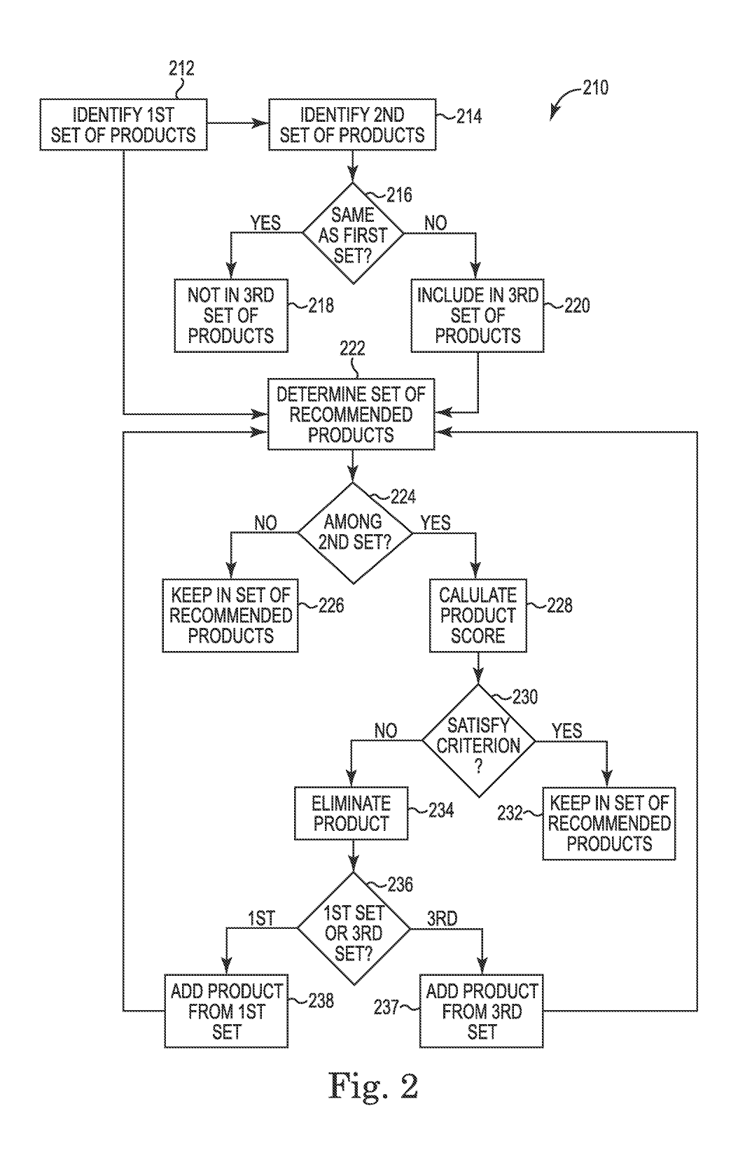

FIG. 2 is a flow chart illustrating an example process 210 for populating a product recommendation list according to the present disclosure.

At 212, a first set of products can be identified using customer data. The first set of products can, for instance, include a recommended set of products identified using an automated product recommendation engine.

For instance, the first set of products can be identified by performing collaborative filtering. The collaborative filtering can result in a calculated affinity score for each product in the first set of products. Calculating an affinity score for each product in the first set of products can, for example, include collaborative filtering applied to data relating to products the customer has, products similar users have, and/or the customer's browsing history (e.g., customer data).

At 214, a second set of products can be identified using social network data. The social network data can include data associated with a social network of the customer. The second set of products can include, for instance, a social network-recommended set of products identified using an automated product recommendation engine.

For instance, the second set of products can be identified by performing collaborative filtering. The collaborative filtering can result in a calculated affinity score for each product in the second set of products. For instance, calculating an affinity score for each product in the second set of products can include collaborative filtering applied to data relating to a subset of users in the social network.

At 216, a determination can be made as to whether each product in the identified second set of products is the same as a product in the identified first set of products.

At 218, in response to determining a product is in the first set of products and/or is an identical to product in the first set of products, the product among the set of second products may not be included in the third set of products. An identical product can include a same product and/or similar product, for example. A product that is not included in the third set of products can include a product in the fourth set of products (e.g., subset of the second set of products that includes products among the second set of products that are also among the first set of products).

At 220, in response to determining and/or identifying the product is different than the products among and/or in the first set of products, the product can be added to a third set of products. Adding products to the third set of products can include identifying the third set of products. A third set of products can include products among the second set of products and not among the first set of products.

At 222, a set of recommended products can be determined among the products in the first set of products (e.g., subset of the set of first products identified at 212) and the third set of products (e.g., subset of the set of third products identified at 220). The set of recommended products can be determined based on the calculated affinity scores. For instance, the products in the set of recommended products can include a subset of products from the first set of products and a subset of products from the third set of products with a highest calculated affinity score among the first set of products and the second set of products.

In some examples of the present disclosure, the amount and/or number of products from each set (e.g., first set and third set) of products can be predetermined and/or predefined. For instance, a first number of products from the first set of products and a second number of products from the third set of products in the set of recommended products can be predetermined. As an example, a first number can include 7 and a second number can include 3; thereby, 7 products from the first set of products and 3 products from the third set of products can be included in the set of recommended products.

The first number of products and the second number of products can include an identical number or a different number. For example, the number of products added to the product recommendation list can be based on the highest affinity scores of products in the first set of products and products in the second set of products, without regard to how many products to add from each set of products (e.g., first number and second number).

In some examples, the first number of products and the second number of products can include a sub-threshold number. For instance, a threshold number of products from the first set and the second set can be predetermined. The threshold number of products can include a sum of a first sub-threshold number (e.g., first number of products from the first set of products) and a second sub-threshold number (e.g., second number of products from the second set of products). As an example, a product recommendation list can be set to a threshold number of 100, with a first sub-threshold number of 50 products from the first set of products and a second sub-threshold number of 50 products from the second set of products.

In various examples of the present disclosure, the process 210 can include determining a function of a rate of success of product recommendations in the first set of products and in the third set of products for the customer. A rate of success of product recommendations, as used herein, can include a percentage of product recommendations that a customer downloads, purchases, selects, and/or clicks on an advertisement of a product in the recommendation. For instance, a customer may have a 40% rate of success with products from the first set of products and a 70% rate of success with products from the third set of products.

The rate of success of product recommendations, for instance, can be used to populate the product recommendation list. For instance, the first number of products from the first set of products (e.g., subset of first products) and the second number of products from the second set of products (e.g., subset of second products) can be determined, predefined, and/or set based on the rate of success of the product recommendations. As an example, based on the calculated rate of success discussed above (e.g., 40% and 70%), the first number can include a smaller number (e.g., 36%) of the product recommendation list than the second number (e.g., 64%).

At 224, a determination can be made as to whether each product in the set of recommended products is among and/or in the second set of products. For instance, the second set of products can include products from the first set of products and products from the third set of products. The third set of products can include products among and/or in the second set of products (e.g., products in the third set of products are in the second set of products). The first set of products can include a subset of products found in both the first set of products and the second set of products, and a subset of products unique to the first set of products.

At 226, in response to determining that a product in the set of recommended products is not in the second set of products (e.g., the product is only in the first set of products), the product can remain on the set of recommended products and/or be added to the product recommendation list.

At 228, in response to determining that a product in the set of recommended products is among and/or in the second set of products, a product score can be calculated for the product. The product score can be calculated using data associated with users in the social network of the customer, for instance. For example, a product score can be calculated for each product in the set of recommended products that is among and/or in the second set of products.

At 230, a determination can be made as to whether the product score of each product in the set of recommended products that is among the second set of products satisfies a criterion. A criterion can include a threshold product score (e.g., 0.99, 0.85, and 0.55) and/or an action by a user (e.g., action associated with a product with product above a threshold product score). A user can include the customer and/or user of the social network of the customer. For instance, a product can remain on the set of recommended products and/or can be added to the product recommendation list if the product score of the product is below a threshold product score (e.g., below 0.85).

At 232, a product that satisfies the criterion (e.g., below the threshold product score and/or user action) can remain on the set of recommended products and/or the product recommendation list of the customer. A product that is from and/or in the set of recommended products that has been determined to not be a product in the second set of products (e.g., at 226) can include a product that satisfies the criterion, for instance. For example, products that do not belong to the second set of products in the set of recommended products may not have a product score calculated and/or may have a predetermined default product score that is below the threshold product score (e.g., zero).

At 234, a product that does not satisfy the criterion can be eliminated. The product eliminated can include a first product from the set of recommended products. A first product from the set of recommended products may not satisfy the criterion, for instance, if the calculated product score of the product is above a threshold product score and/or the customer has not made an indication of interest toward the first product (e.g., no user action). Determining if a customer has not made an indication of interest can include determining if no user action has occurred (e.g., user inaction). User inaction can include inaction by the customer and/or inaction by a user in the social network (e.g., close user, friend, and peer). For instance, inaction can include the customer not selecting the product, and/or a user not recommending and/or not forwarding a social network-promoted product to the customer.

In some examples of the present disclosure, user inaction can include a user not recommending the product to the customer. For example, the product can include a second product in the set of recommended products. A second product can include a recommended product from a social network-marketing campaign (e.g., a social network-promoted product and object of a social network-marketing campaign). To refine the recommendations, products that were part of a social network-marketing campaign in recent time (e.g., hours, days, and months) can be considered before the product recommendation has to be offered to the customer (e.g., before a product from the product recommendation list is offered to the customer).

A social network-promoted product, as used herein, can include a promoted product from a marketing campaign of an advertiser and/or seller. If the social network-marketing campaign with the product as an object involved more than N users that belong to the customer's social network, the product can be treated differently. The promoted product can, for example, include a discounted price for a user if the user recommends and/or forwards the promoted product to friends and/or peers in the user's social network. If a user is a close friend of the customer in the social network and did not recommend and/or forward the promoted product to the customer, it can signal that the customer may not have an interest for the promoted product (e.g., the product may not match the customers taste).

A product can, for instance, be eliminated and/or removed from the set of recommended products and/or the product recommendation in two cases: 1) having a product score higher than the threshold product score, and 2) having a product score lower than the threshold product score, the product being involved in a social network-marketing campaign (e.g., object of a social network-marketing campaign), and the product not being recommended by close friends of the customer in the social network. Therefore, social network-marketing campaigns can be used in a complementary fashion with product recommendations. A seller can, for example, use such campaigns to elicit information and refine product recommendations.

The criterion, in accordance with various examples of the present disclosure, can include a criteria and/or multi-step criterion. First, a product score of the product is evaluated. A product with a product score above a threshold product score (e.g., product with an above threshold product score and no action by the customer and/or no indication of interest by the customer) is eliminated from the set of recommended products and/or product recommendation list. A product with a product score below the threshold product score can be evaluated for user action (e.g. in action by a user in the social network). If the product with a product score that is below the threshold product score is the object of a social network-marketing campaign, and did not have user action (e.g., users that that belong to the customer's social network and are involved in the campaign did not recommend the product to the customer), the product is eliminated from the set of recommended products and/or product recommendation list of the customer.

A social network-promoted product can involve a special treatment of the measure of a user's influence. For instance, a user's influence related to a product promoted through a social network may not be considered when an influence of the user is computed (e.g., in the product score) as the recommendation of such product may be due to the advantageous economic condition associated with the promotions (e.g., marketing campaign). Thus, the user's influence level can be artificially inflated.

At 236, a determination can be made as to whether an eliminated product is from the first set of products or the third set of products. At 237, in response to determining that the eliminated product is from the third set of products, a revised product from the third set of products can be added to the set of recommended products. At 238, in response to determining that the eliminated product is from the first set of products, a revised product from the first set of products can be added to the set of recommended products.

The revised product added can include a product from the first set of products and/or third set of products with a highest affinity score among the remaining first set of products and/or third set of products, and/or a calculated product score that satisfies a criterion (e.g., below a threshold product score and/or user action has occurred).

The process 210 can include populating the product recommendation list of the customers with the set of recommended products and/or revised set of recommended products based on the calculated product scores for each product satisfying the criterion. For example, the set of recommended products and/or the revised set of recommended products can include a candidate number of products. If each of the candidate number of products in the set of recommended products and/or revised set of recommended products satisfies the criterion, the set of recommended products and/or revised set of recommended products can include the populated product recommendation list.

In various examples of the present disclosure, the process 210 can identify a number of first set of products (e.g., first number) and/or a number of third set of products (e.g., second number) in the product recommendation list and/or set of recommended products is below a threshold in response to eliminating a product. For instance, eliminating a product from the first set of products can result in the first number of products (e.g., the subset of first set of products) being below a threshold to populate the product recommendation list and/or set of recommended products. Eliminating a product from the third set of products can result in the second number of products (e.g., the subset of third set of products) being below a threshold to populate the product recommendation list and/or set of recommended products.

If the population is below a threshold, the product recommendation list can be repopulated with a revised set of recommended products. For instance, if an eliminated product is from the number of the first set of products and/or the number of the third set of products, the process 210 can re-start at the step of determining a set of recommended products 222. Re-starting at step 222 can include replacing an eliminated product with a revised product from the set of origin of the eliminated product, for example. The process 210 can, for instance, be recursive until all products in the set of recommended products (e.g., candidate products) pass the criterion. A revised product can include a product that was not in the initial set of recommended products with the highest affinity score of the remaining products that were not in the initial set of recommended products, for example.

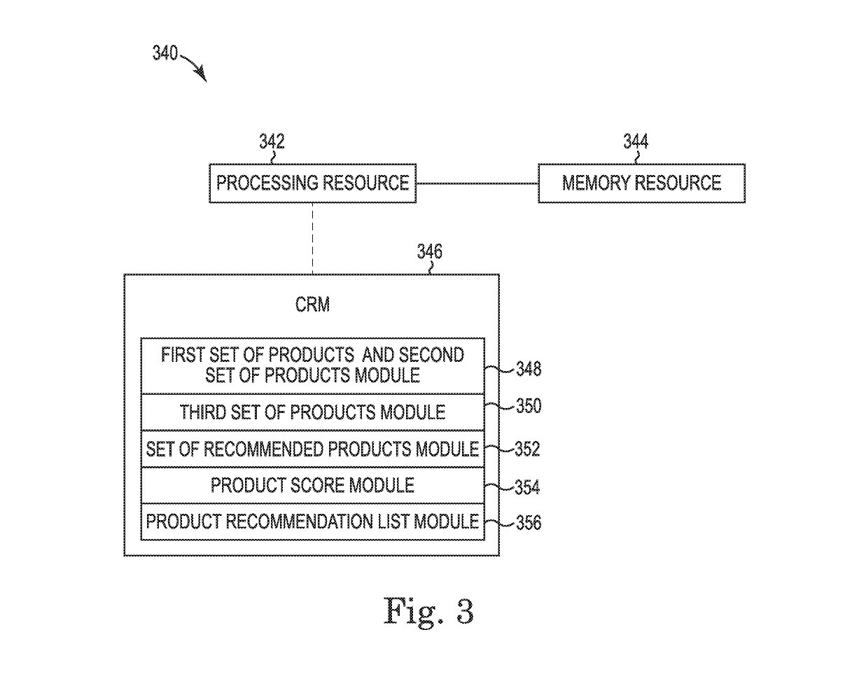

FIG. 3 is a block diagram 340 illustrating a processing resource 342, a memory resource 344, and a computer-readable medium 346 according to the present disclosure. The processing resource 342 and the memory resource 344 can be local to a computing device, such as on a router, switch, server, or other network device, etc. The computer-readable medium (CRM) 346 (e.g., a tangible, non-transitory medium) and/or the memory resource 344 can store a set of instructions executable by the processing resource 342. The CRM 346 can be local to a computing device or remote therefrom. For those examples in which the CRM 346 is remote from the computing device, the instructions can be loaded into the memory resource 344 of the computing device.

As used herein, a processing resource 342 can include one or a plurality of processors such as in a parallel processing system. A memory resource 344 can include memory addressable by the processing resource 342 for execution of computer readable instructions (e.g., program instructions). The memory resource 344 can include volatile and/or non-volatile memory such as random access memory (RAM), static random access memory (SRAM), electronically erasable programmable read-only memory (EEPROM), magnetic memory such as a hard disk, floppy disk, and/or tape memory, a solid state drive (SSD), flash memory, phase change memory, etc. The CRM 346 can also be stored in remote memory managed by a server and represent an installation package that can be downloaded, installed, and executed.

As shown in the example of FIG. 3, the CRM 346 can include a number of modules 348, 350, 352, 354, and 356. The number of modules can include a first set of products and second set of products module 348, a third set of products module 350, a set of recommended products module 352, a product score module 354, and a product recommendation list module 356. The number of modules 348, 350, 352, 354, and 356 can include program instructions to perform particular acts, task, and/or functions as described herein when executed by the processing resource 342.

The number of modules 348, 350, 352, and 354 can be modules, can have sub-modules and/or be sub-modules of other modules. For example, the first set of products and the second set of products module 348, can be sub-modules (e.g., a first set of products module and a second set of products module). The set of recommended products module 352 and the product score module 354 can be contained within the product recommendation list module 356, for example. Examples of the present disclosure are not limited to these examples and the number of modules 348, 350, 352, 354, and 356 can be individual modules separate and distinct from one another.

By way of illustration and not by way of limitation, the first set of products and second set of products module 348 can include a number of instructions (e.g., a number of CRI) that can be executed by the processing resource 342 to perform or achieve the particular act or carry out the act of identifying a first set of products using customer data based on a calculated affinity score for each product in the first set of products and identifying a second set of products using social network data based on a calculated affinity score for each product in the second set of products.

For instance, an automatic product recommendation engine can be used to identify the first set of products, the second set of products and/or calculate the affinity scores. In some examples, an automated social network recommendation engine can be used to identify the second set of products and calculate the affinity scores for each product in the second set of products. The automated social network recommendation engine can include the automated product recommendation engine and/or a separate product recommendation engine, for example.

The third set of products module 350 can include a number of instructions that can be executed by the processing resource 342. For instance, the third set of products module 350 can identify a third set of products. The third set of products can include products among the second set of products that are not among the first set of products.

The set of recommended products module 352 can include a number of instructions that can be executed by the processing resource 342. For example, the set of recommended products module 352 can determine a set of recommended products among the products in the first set of products and the third set of products based on the calculated affinity score. For instance, the set of recommended products can include a subset of the first set of products and a subset of the third set of products.

The set of recommended products module 352 can eliminate a first product from the set of recommended products in response to a calculated product score of the first product being above a threshold product score and user inaction. For instance, the threshold product score and user action can include a criterion. No user action can include a customer not indicating an interest in the product and/or a close user not recommending a social-network promoted product to the customer in the social network.

In response to eliminating a product, the set of recommended products module 352 can revise the set of recommended products to include a revised product. A revised product can include a new product from the first set of products and/or third set of products that is not yet among the set of recommended products. For instance, the new product can include a higher affinity score than the remaining products. A new product can be from the same set of products as the eliminated product. For instance, if a product was eliminated from the first set of products, a new product can be added from the first set of products.

In some examples of the present disclosure, the set of recommended products module 352 can eliminate a second product from the set of recommended products in response to a user (e.g., user in the social network) not recommending the second product to the customer. The second product from the product recommendation list can include social network-promoted products, for instance. For example, a social network-promoted product can include an object of a social network-marketing campaign.

The product score module 354 can include a number of instructions that can be executed by the processing resource 342. For example, the product score module 354 can calculate a product score for each product in the determined set of recommended products that is among the second set of products using social network data. The product score can include a score calculated in addition to an affinity score. The product score can, for instance, be based on social network data and/or information (e.g., user actions).

The product recommendation list module 356 can include a number of instructions that can be executed by the processing resource 342. For example, the product recommendation list module 356 can populate the product recommendation list with the set of recommended products based on the calculated products scores for each product satisfying a criterion. The criterion can include the threshold product score and/or user action (e.g., indication of interest in a product with a product score above a threshold product score).

In various examples of the present disclosure, a tracking module (not pictured) can include a number of instructions that can be executed by the processing resource 342 to track data associated with an effectiveness of product recommendations of products on the product recommendation list of the customer. An effectiveness of product recommendations can include a download of a product, a purchase of a product, and/or a clicking of an advertisement. The data tracked can include separate tracking of an effectiveness of the product recommendations for products in the first set of products and products in the second set of products.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

What is claimed:

1. A computer-implemented method for populating a product recommendation list comprising:
identifying a first set of products using customer data and a second set of products using social network data;
identifying a third set of products, wherein the third set of products includes products in the second set of products and not in the first set of products;
calculating a product score for each product in the second set of products; and
populating the product recommendation list of the customer with a subset of the first set of products and a subset of the third set of products based on the calculated product scores.

2. The method of claim 1, further including identifying the first set of products and the second set of products based on an affinity score representing an affinity of the customer toward a product.

3. The method of claim 1, wherein the product score calculated for each product in the second set of products includes a function of measurable interactions and relationships in the social network.

4. The method of claim 1, further including populating the product recommendation list to a threshold number of products.

5. The method of claim 1, further including:
determining a set of recommended products from the first set of products and the third set of products; and
calculating the product score for each product in the set of recommended products that is in the second set of products.

6. The method of claim 1, wherein the customer data further includes data relating to products the customer has, products related customers have, and the customer's browsing history.

7. The method of claim 1, wherein social network data further includes data relating to a subset of users in the social network.

8. A non-transitory computer-readable medium storing a set of instructions executable by a processing resource to:
identify a first set of products using customer data and a second set of products using social network data based on a calculated affinity score for each product in the first set of product and the second set of products;
identify a third set of products, wherein the third set of products includes products among the second set of products and not among the first set of products;
determine a set of recommended products among the products in the first set of products and the third set of products based on the calculated affinity scores;
calculate a product score for each product in the set of recommended products that is among the second set of products using data associated with users in the social network; and
populate the product recommendation list with the set of recommended products based on the calculated product scores for each product satisfying a criterion.

9. The non-transitory computer-readable medium of claim 8, wherein the instructions are executable to determine a function of a rate of success of product recommendations in the first set of products and the third set of products for the customer.

10. The non-transitory computer-readable medium of claim 8, wherein the instructions are executable to populate the product recommendation list based on a determined function of a rate of success of product recommendations.

11. The non-transitory computer-readable medium of claim 8, wherein the instructions are executable to eliminate a product from the set of recommended products based on the product having a higher product score than a threshold product score.

12. The non-transitory computer-readable medium of claim 8, wherein the instructions are executable to revise the set of recommended products to include a revised product in response to eliminating a product from the set of recommended products.

13. A system for populating a product recommendation list, comprising:
a memory resource; and
a processing resource coupled to the memory resource to implement;
a first set of products and second set of products module to:
identify a first set of products using customer data based on a calculated affinity score for each product in the first set of products; and
identify a second set of products using social network data based on a calculated affinity score for each product in the second set of products;
a third set of products module to identify a third set of products, wherein the third set of products includes products among the second set of products and not among the first set of products;
a set of recommended products module to:
determine a set of recommended products among the products in the first set of products and the third set of products based on the calculated affinity scores;
eliminate a first product from the set of recommended products in response to a calculated product score of the first product being above a threshold product score and no user action; and
revise the set of recommended products with a revised product from at least one of the first set of products and the third set of products in response to eliminating the first product;
a product score module to calculate the product score for each product in the set of recommended products that is among the second set of products using social network data; and
a product recommendation list to populate the product recommendation list of the customer with the revised set of recommended products.

14. The system of claim 12, wherein the set of recommended products module is configured to:
eliminate a second product from the set of recommended products in response to a user not recommending the second product to the customer; and
wherein the second product from the set of recommended products is an object of a social network-marketing campaign.

15. The system of claim 12, further comprising a tracking module to track data associated with an effectiveness of product recommendations of products in the product recommendation list of the customer.
